(19) United States
(12) Patent Application Publication
(10) Pub. No.: US 2020/0278645 A1
(43) Pub. Date: Sep. 3, 2020

(54) WATCH EXTERIOR PART AND WATCH

(71) Applicant: Seiko Epson Corporation, Tokyo (JP)

(72) Inventors: Yoshiki TAKAHASHI, Shiojiri (JP); Yuzuru TSUKAMOTO, Yamagata (JP)

(21) Appl. No.: 16/802,662

(22) Filed: Feb. 27, 2020

(30) Foreign Application Priority Data
Feb. 28, 2019 (JP) 2019-035537

(51) Int. Cl. G04B 37/22

(52) U.S. Cl. CPC G04B 37/22

(57) ABSTRACT

A watch exterior part includes, in order, a substrate made of a metal, a foundation film including any of Ti, TiCN, TiC, TiN, TiO₂, Si, and SiO₂, and a metal coating mainly including Ru or including a Ru—Ti alloy, the metal coating being configured as an outermost film.

The present application is based on, and claims priority from JP Application Serial Number 2019-035537, filed Feb. 28, 2019, the disclosure of which is hereby incorporated by reference herein in its entirety.

### BACKGROUND

### 1. Technical Field

The present disclosure relates to a watch exterior part and a watch.

### 2. Related Art

Watch exterior parts require an excellent aesthetic appearance. To achieve such a purpose, techniques of forming a metal coating on the surface of a watch exterior part are known.

For example, JP-A-2005-264191 discloses a decorative product including a substrate that is mainly composed of Ti and/or stainless steel at least at a portion near the surface thereof, a first coating provided on the substrate and mainly composed of TiCN, and a second film provided on the substrate on the side opposite to the first film and mainly composed of M (where M is at least one of Ti, Pt, Pd, and In), in which the sum of the percentage content of C and the percentage content of N in the first film is from 5 to 30 wt %. JP-A-2005-264191 also discloses a watch provided with the decorative product. In addition, JP-A-2005-264191 discloses that the decorative product described in JP-A-2005-264191 can be applied to a watch exterior part.

In the watch exterior part including the second coating mainly composed of M disclosed in JP-A-2005-264191, however, the second coating, which is softer than the first coating, is provided at the outermost layer, and consequently the problem of reduction in appearance quality due to scratches during use and the like may be caused. For a watch exterior part, it is desirable that scratches be not easily left on the surface from the perspective of the aesthetic appearance and the like.

### SUMMARY

A watch exterior part of the present disclosure includes, in order, a substrate made of a metal, a foundation film including any of Ti, TiCN, TiC, TiN, TiO₂, Si, and SiO₂, and a metal coating mainly including Ru or including Ru—Ti alloy, the metal coating being configured as an outermost film.

In the watch exterior part of the present disclosure, the substrate may include any of stainless steel, Ti, and Ti alloy.

In the watch exterior part of the present disclosure, a content of the Ru in an entirety of the Ru—Ti alloy may be from 25 mass % to 75 mass %, and a content of the Ti in the entirety of the Ru—Ti alloy may be from 25 mass % to 75 mass %.

In the watch exterior part of the present disclosure, a content of the Ru in an entirety of the Ru—Ti alloy may be from 50 mass % to 75 mass %, and a content of the Ti in the entirety of the Ru—Ti alloy may be from 25 mass % to 50 mass %.

In the watch exterior part of the present disclosure, an average thickness of the metal coating may be from 0.1 μm to 2.0 μm.

In the watch exterior part of the present disclosure, an average thickness of the foundation film may be from 0.01 μm to 0.50 μm.

In the watch exterior part of the present disclosure, an intermediate coating may be provided between the foundation film and the metal coating.

In the watch exterior part of the present disclosure, the intermediate coating a film including TiCN.

In the watch exterior part of the present disclosure, an average thickness of the intermediate coating may be from 0.1 μm to 2.0 μm.

In the watch exterior part of the present disclosure, a surface at a side provided with the metal coating may have a nanoindenter hardness from 1000 to 1500, the nanoindenter hardness being measured with a load of 1.000 mN.

A watch of the present disclosure includes the watch exterior part.

### BRIEF DESCRIPTION OF THE DRAWINGS

FIG. 1 is a partial cross-sectional view of a watch exterior part according to a first embodiment.

FIGS. 2A to 2C are cross-sectional views illustrating a preferred embodiment of a method of producing the watch exterior part illustrated in FIG. 1. FIG. 2A is a drawing illustrating a substrate, FIG. 2B is a drawing illustrating a foundation film formed in a foundation film forming step, and FIG. 2C is a drawing illustrating a metal coating formed in a metal coating step.

FIG. 3 is a partial cross-sectional view of a watch exterior part according to a second embodiment of the present disclosure.

FIG. 4 is a partial cross-sectional view of a watch according to an embodiment of the present disclosure.

### DESCRIPTION OF EXEMPLARY EMBODIMENTS

Watch Exterior Part

A watch exterior part according to this embodiment refers to a part that can be visually recognized from the outside. The watch exterior part is a concept that includes a part incorporated inside the watch and is not limited to a part that is exposed to the outside of the watch when in use.

Examples of the watch exterior part include a watch case, a watch band, a dial, a watch hand, a bezel, a crown, a button, a cover glass, a glass edge, a dial ring, a panel cover and a packing. Examples of the watch case include a body, a case back, and a one-piece case where the body and the case back are integrated. Examples of the watch band include a band clasp, a part used for attaching and detaching the band, and a part used for attaching and detaching a bangle. Examples of the bezel include a rotating bezel. Examples of the crown include a thread-locking crown.

A first embodiment of the present disclosure is described below with reference to the accompanying drawings.

### First Embodiment

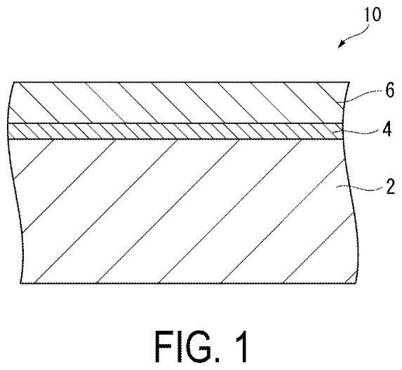

FIG. 1 is a partial cross-sectional view of a watch exterior part 10 of the first embodiment.

The watch exterior part 10 illustrated in FIG. 1 includes a substrate 2 made of metal, a foundation film 4, and a metal coating 6 serving as the outermost film in this order.

The foundation film 4 is composed of any of Ti, TiCN, TiC, TiN, TiO₂, Si, and SiO₂.

The metal coating 6 is mainly composed of Ru or composed of a Ru—Ti alloy.

The expression “mainly composed of Ru” means that the content of Ru of the entire metal coating 6 is 90 mass % or greater. The content of Ru is preferably 95 mass % or greater, more preferably 98 mass % or greater.

The expression “composed of a Ru—Ti alloy” means that the content of the Ru—Ti alloy of the entire metal coating 6 is 90 mass % or greater. The content of the Ru—Ti alloy is preferably 95 mass % or greater, more preferably 98 mass % or greater.

In the following description, a film mainly composed of Ru may be referred to as a “Ru film”, and a film composed of a Ru—Ti alloy may be referred to as a “Ru—Ti film”.

In the watch exterior part 10 of this embodiment, a Ru film or a Ru—Ti film, whose hardness of the metal coating itself is set to a value greater than that of a Pt film or a Ti film that has been used as a metal coating of a watch exterior part in the related art, is provided at the outermost film.

Further, in the watch exterior part 10 of this embodiment, the metal coating 6 whose hardness of the metal coating itself is increased is provided on the foundation film 4 composed of any of Ti, TiCN, TiC, TiN TiO₂, Si, and SiO₂, and thus the watch exterior part 10 has a structure in which the hardness in the entirety of the surface side of the metal coating 6 of the watch exterior part 10 is increased.

Therefore, with the watch exterior part 10 of this embodiment, scratches are not easily left on the surface.

Note that, in the present specification, the property of being resistant to scratches may be expressed as being excellent in scratch resistance.

In addition to the effects of excellent scratch resistance, the watch exterior part 10 of this embodiment has the following effects.

With the structure in which the hardness in the entirety of the surface side of the metal coating 6 is increased, the watch exterior part 10 of this embodiment also has excellent dent resistance. In other words, the watch exterior part 10 of this embodiment causes less depressions due to scratches and dents.

The watch exterior part 10 of this embodiment has a bright new silver color since the Ru film or the Ru—Ti film serving as the outermost film has less yellowness and has a brightness closer to white. In addition, since the watch exterior part 10 of this embodiment is bright, the fingerprint is less noticeable.

Further, since the Ru film and the Ru—Ti film serving as the outermost film have a resistance to metal allergy, a person with a metal allergy can also wear the watch exterior part 10 of this embodiment.

In the present specification, as an index of the resistance to scratches on the surface, i.e., excellence in scratch resistance, a nanoindenter hardness measured using a nanoindentation tester (manufactured by ELIONIX; product number: ENT-1100a) is used.

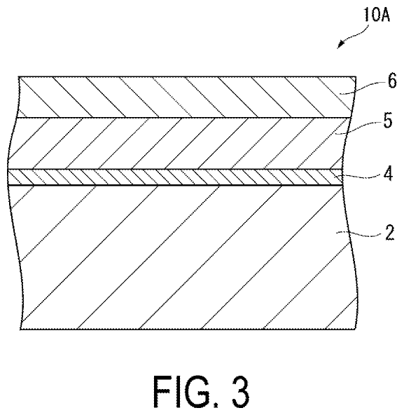

For example, in FIG. 1, when the nanoindenter hardness is measured from the surface side of the metal coating 6, it is recognized that the hardness that is not affected by the foundation film 4 is measured. In FIG. 3, which will be described later, it is recognized that the hardness of an intermediate coating 5 that is not affected is measured.

Therefore, in the present specification, the nanoindenter hardness is considered as the surface hardness of the metal coating 6 itself, and it is determined that the greater the value of the nanoindenter hardness, the less easily scratches are left on the surface of the watch exterior part.

The method of measuring the nanoindentation hardness is described below.

As an index of the dent resistance, the Vickers hardness measured using a micro Vickers hardness testing machine (manufactured by Mitutoyo; product number: HM-200) is used.

For example, in FIG. 1, when the Vickers hardness is measured from the surface side of the metal coating 6, the hardness affected by the hardness of the foundation film 4 may be measured. In FIG. 3 described later, the hardness affected by the hardness of the intermediate coating 5 may be measured.

Therefore, in the present specification, the Vickers hardness is considered as the surface hardness as the watch exterior part, and it is determined that the greater the Vickers hardness value, the better the dent resistance of the watch exterior part.

The method of measuring the Vickers hardness is described later.

Next, a configuration of the watch exterior part 10 according to this embodiment is described.

Substrate

The substrate 2 is made of metal. In other words, the substrate 2 is composed of a metal material. The expression “the substrate 2 is composed of a metal material” means that the content of the metal material of the entire substrate 2 is 90 mass % or greater. The content of the metal material is preferably 95 mass % or greater, more preferably 98 mass % or greater.

Examples of the metal material include Fe, Cu, Zn, Ni, Ti Mg Mg Cr, Mn, Mo, Nb, Al, V, Zr, Sn, Au, Pd, Pt, Ag, In, and an alloy including at least one of them.

Among them, from the perspective of processability and adhesion to the foundation film 4, the metal material is preferably Fe, Cu, Zn, Ni, Ti, Al, or an alloy including at least one of them, more preferably, stainless steel, Ti, or a Ti alloy.

In other words, it is preferable that the substrate 2 be composed of stainless steel, Ti, or a Ti alloy. With such a configuration, the durability of the final product of the watch exterior part 10 is easily improved.

Examples of the stainless steel include Fe—Cr alloys and Fe—Cr—Ni alloys, or more specifically, SUS405, SUS430, SUS434, SUS444, SUS429, SUS430F, SUS304, SUS303, SUS316 SUS316L, SUS316J1, and SUS316J1L.

Examples of the Ti alloy include α-alloys, α-β alloys and β-alloys.

The shape of the substrate 2 is not limited. As the substrate 2, it is possible to use watch exterior parts of various shapes before forming the foundation film 4.

Foundation Film

From the perspective of improving the adhesion to the substrate 2, the foundation film 4 is preferably provided on the surface of the substrate 2. In this case, it suffices that the foundation film 4 is provided on at least a part of the surface of the substrate 2.

The foundation film 4 is composed of any of Ti, TiCN, TiC, TiN, TiO₂, Si, and SiO₂. The foundation film 4 is preferably composed of Ti or TiCN, more preferably Ti. With such a configuration, the adhesion to the substrate 2 is further improved, and the durability of the watch exterior part 10 is easily improved.

Here, the expression “the foundation film 4 is composed of Ti” means that the content of Ti of the entire foundation film 4 is 90 mass % or greater. The content of Ti is preferably 95 mass % or greater, more preferably 98 mass % or greater. The same applies to the case where the foundation film 4 is composed of TiCN, TiC, TiN, TiO₂, Si, or SiO₂.

The average thickness of the foundation film 4 is preferably from 0.01 μm to 0.50 μm, more preferably from 0.03 μm to 0.40 μm, still more preferably from 0.05 μm to 0.30 μm. When the average thickness of the foundation film 4 is 0.01 μm or greater, the foundation film 4 is less affected by the stress of the metal coating 6. In addition, when the average thickness of the foundation film 4 is 0.01 μm or greater, the adhesion to the substrate 2 is easily ensured.

When the average thickness of the foundation film 4 is 0.50 μm or less, the membrane stress of the foundation film 4 is suppressed, and, as a result, the adhesion to the substrate 2 is favorable. In addition, when the average thickness of the foundation film 4 is 0.50 μm or less, the smoothness of the foundation film 4 is favorable.

The method of measuring the average thickness of the foundation film 4 is described in the Examples section.

Metal Coating

From the perspective of improving the adhesion to the foundation film 4, it is preferable that the metal coating 6 be provided on the surface of the foundation film 4. In this case, from the perspective of providing scratch resistance, it is preferable that the metal coating 6 be provided at least at a location where the external impact is likely to be exerted on the surface of the foundation film 4.

The metal coating 6 is a Ru film or a Ru—Ti film. The metal coating 6 is the outermost film of the watch exterior part 10.

The metal coating 6 is preferably a Ru—Ti film.

When the metal coating 6 is a Ru—Ti film, preferably, the content of Ru of the entire alloy is from 25 mass % to 75 mass % and the Ti content of the entire Ru—Ti alloy is from 25 mass % to 75 mass %; more preferably, the content of Ru of the entire Ru—Ti alloy is from 40 mass % to 75 mass % and the Ti content of the entire Ru—Ti alloy is from 25 mass % to 60 mass %; still more preferably, the content of Ru of the entire alloy is from 50 mass % to 75 mass % and the content of Ti of the entire Ru—Ti alloy is from 25 mass % to 50 mass %.

In other words, when the content ratio of Ru and Ti of the entire Ru—Ti alloy is expressed as “Ru/Ti”, the mass ratio of “Ru/Ti” is preferably from 25/75 to 75/25, more preferably from 40/60 to 75/25, still more preferably from 50/50 to 75/25.

When the mass ratio of Ru/Ti is from 25/75 to 75/25, the external appearance is less darkened, and the aesthetic appearance is more easily ensured.

When the mass ratio of Ru/Ti is from 40/60 to 75/25, the brightness improves. When the mass ratio of Ru/Ti is from 50/50 to 75/25, the watch exterior part ensuring both brightness and hardness is easily obtained. In other words, the watch exterior part having excellent aesthetic appeal and scratch resistance is easily obtained.

The average thickness of the metal coating 6 is preferably from 0.1 μm to 2.0 μm, more preferably from 0.15 μm to 2.0 μm, still more preferably from 0.2 μm to 2.0 μm.

When the average thickness of the metal coating 6 is 0.1 μm or greater, the color of the foundation film 4 is less seen through, and the aesthetic appeal is more easily improved. In addition, when the average thickness of the metal coating 6 is 0.1 μm or greater, the hardness of the metal coating 6 is more easily improved.

When the average thickness of the metal coating 6 is 2.0 μm or less, the increase in internal stress is suppressed, and the adhesion to the foundation film 4 is more easily improved.

The method of measuring the average thickness of the metal coating 6 is described in Examples section.

When the ratio of the average thickness of the metal coating 6 to the average thickness of the foundation film 4 is expressed as “the average thickness of the metal coating 6/the average thickness of the foundation film 4”, “the average thickness of the metal coating 6/the average thickness of the foundation film 4” is preferably from 0.2 to 200, more preferably from 0.4 to 70, still more preferably from 0.7 to 40.

When “the average thickness of the metal coating 6/the average thickness of the foundation film 4” is from 0.2 to 200, the scratch resistance is more easily improved.

Characteristics of Watch Exterior Part of First Embodiment

Nanoindenter Hardness

In the watch exterior part 10 of the first embodiment, the nanoindenter hardness measured with a load of 1.000 mN from the surface side of the metal coating 6 is preferably 1000 or greater, more preferably 1200 or greater, still more preferably 1400 or greater.

Preferably, the upper limit of the nanoindenter hardness is, but not limited to, 1500 or less from the perspective of material selection.

When the hardness of the nanoindenter is 1000 or greater, the scratch resistance of the watch exterior part 10 is improved. As a result, the watch exterior part 10 can be used over a long period of time while maintaining a state where small scratches are less likely to be left.

The nanoindenter hardness can be adjusted by changing the type of the metal of the metal coating 6 and the content ratio of the metal. For example, when the metal coating 6 is formed using a Ru—Ti alloy target by a dry plating method, the nanoindenter hardness can be adjusted by changing the content ratio of Ru and Ti of the entire Ru—Ti alloy target.

In the present specification, the nanoindenter hardness can be measured by the method in accordance with ISO 14577 with a nanoindentation tester (manufactured by ELIONIX; product number: ENT-1100a) under the following conditions.

A test piece with a size of 20 mm×40 mm is cut out of the watch exterior part. Next, the nanoindenter hardness is measured at 10 locations randomly selected for the test piece, and the average value thereof is used as the nanoindenter hardness.

Condition

Test Load [mN]: 1.000

Number of Divisions: 500

Step Interval [msec]: 20

Retention Time [msec]: 10000

Vickers Hardness

In the watch exterior part 10 of the first embodiment, the Vickers hardness measured with a load of 25 gf from the surface side of the metal coating 6 is preferably 150 or greater, more preferably 200 or greater, still more preferably 230 or greater.

Preferably, the upper limit of the Vickers hardness is, but not limited to, 1500 or less from the perspective of material selection.

When the Vickers hardness is 150 or greater, the dent resistance of the watch exterior part 10 is improved. As a result, the watch exterior part 10 can be used for a long period of time while maintaining a state where dents are less likely to be left.

The Vickers hardness can be adjusted by changing the type and the thickness of the foundation film 4 or the metal coating 6, for example.

In the present specification, the Vickers hardness can be measured using a micro Vickers hardness testing machine (manufactured by Mitutoyo; product number: HM-200) by a method in accordance with JIS B 7725 (2010).

A test piece with a size of 20 mm×40 mm is cut out of the watch exterior part. Next, the Vickers hardness is measured at five locations randomly selected for the test piece, and the average value is used as the Vickers hardness.

Condition

Load: 25 gf

Method of Producing Watch Exterior Part of First Embodiment

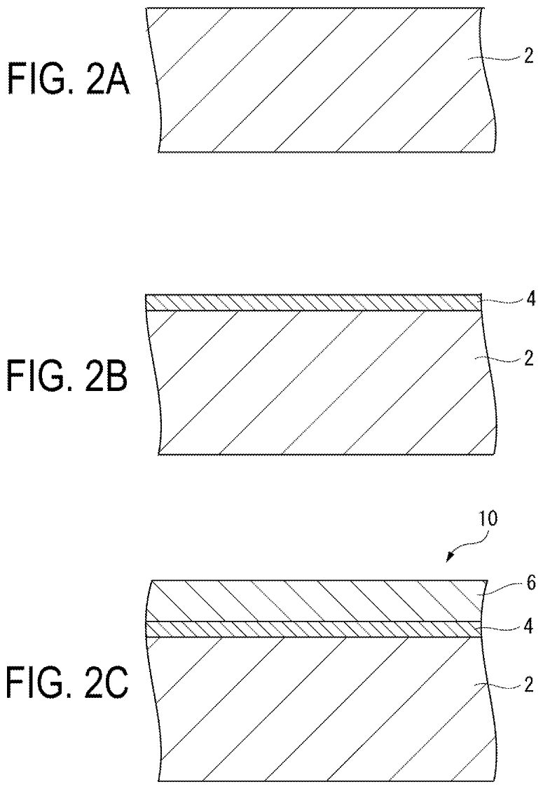

FIGS. 2A to 2C are cross-sectional views illustrating a preferred embodiment of the method of producing the watch exterior part 10 illustrated in FIG. 1.

The method of producing the watch exterior part 10 of this embodiment includes a foundation film forming step of forming the foundation film 4 on the substrate 2, and a metal coating step in the formation of the metal coating 6 on the foundation film 4.

With the manufacturing method of this embodiment, the watch exterior part 10 having excellent scratch resistance is obtained.

FIG. 2A is a diagram illustrating the substrate 2.

The substrate 2 is composed of, for example, the metal material exemplified in the above-described section of the substrate.

The substrate 2 may be formed by any method. Examples of the method of forming the substrate 2 include pressing, cutting, forging, casting, powder metallurgical sintering, metal injection molding (MIM), and lost-wax processing.

Surface processing such as mirror finishing, grooving, and satin finishing may be provided on the surface of the substrate 2. Thus, various degrees of gloss can be provided to the surface of the resulting watch exterior part 10, and the aesthetic appeal of the resulting watch exterior part 10 can be improved. For example, the mirror finishing can be performed using known polishing methods, and methods such as buffing (feather) polishing, barrel polishing, and other mechanical polishing may be adopted.

In addition, by providing the surface processing on the substrate 2, defects such as chipping are less likely to occur in the foundation film 4. As a result, the yield can be improved.

Foundation Film Forming Step

FIG. 2B is a drawing illustrating a state where the foundation film 4 is formed in a foundation film forming step.

In FIG. 2B, the foundation film 4 is formed on the surface of the substrate 2.

The method of forming the foundation film 4 is not limited, and examples of the method include spin coating, dipping, brush painting, coating, a wet plating method, a chemical vapor deposition (CVD) method, a dry plating (vapor film formation) method, and thermal spraying.

Examples of the coating include spray coating, electrostatic coating, and electrodeposition coating. Examples of the wet plating method include electrolytic plating, immersion plating, and electroless plating. Examples of the chemical vapor deposition method include a thermal CVD method, a plasma CVD method, and a laser CVD method. Examples of the dry plating method include a vacuum deposition method, a sputtering method, and an ion plating method.

The method of forming the foundation film 4 is preferably a dry plating method. The foundation film 4 can be formed by a dry plating method using a target made of the material of the foundation film 4 in a desired gas atmosphere, for example.

By forming the foundation film 4 by a dry plating method, the foundation film 4 having uniform thickness, homogeneity, and excellent adhesion to the substrate 2 is easily obtained. As a result, the durability of the final product of the watch exterior part 10 can be improved.

Among dry plating methods, an ion plating method is preferable from the perspective of obtaining the foundation film 4 with excellent adhesion to the substrate 2.

Note that the average thickness of the foundation film 4 is adjusted by changing the film formation time.

Metal Coating Step

FIG. 2C is a diagram illustrating a state where the metal coating 6 is formed in a metal coating step.

In FIG. 2C, the metal coating 6 is formed on the surface of the foundation film 4.

The method of forming the metal coating 6 is not limited, and examples of the method include methods similar to the method of forming the foundation film 4.

The method of forming the metal coating 6 is preferably a dry plating method. The metal coating 6 can be formed by a dry plating method using a Ru target or a Ru—Ti alloy target in a desired gas atmosphere, for example.

When the content ratio of Ru and Ti of the entire Ru—Ti alloy target is represented by “RuM/TiM”, the mass ratio of “RuM/TiM” is preferably from 25/75 to 75/25, more preferably from 40/60 to 75/25, still more preferably from 50/50 to 75/25.

When the mass ratio of “RuM/TiM” is from 25/75 to 75/25, the external appearance is less darkened, and a watch exterior part whose aesthetic appearance is ensured is easily obtained.

When the mass ratio of “RuM/TiM” is from 40/60 to 75/25, a watch exterior part having improved brightness is easily obtained.

When the mass ratio of “RuM/TiM” is from 50/50 to 75/25, a watch exterior part ensuring both brightness and hardness is easily obtained. In other words, the watch exterior part having excellent aesthetic appeal and scratch resistance is easily obtained.

By forming the metal coating 6 by a dry plating method, the metal coating 6 having a uniform thickness and homogeneity is easily obtained. As a result, the durability of the final product of the watch exterior part 10 can be improved.

Among dry plating methods, an ion plating method is preferable from the perspective of obtaining the metal coating 6 with excellent adhesion to the foundation film 4.

Note that the average thickness of the metal coating 6 is adjusted by changing the film formation time.

When the foundation film forming step and the metal coating step are performed by a dry plating method, the foundation film forming step and the metal coating step can be continuously performed in the same apparatus without removing the substrate 2 from the inside of the apparatus by changing the type of target and the composition of the gas in the vapor film formation apparatus. Thus, the watch exterior part 10 with improved durability and excellent adhesion between the substrate 2 and the foundation film 4 and between the foundation film 4 and the metal coating 6 is easily obtained. In addition, the productivity of the watch exterior part 10 can be improved.

For example, in the case where both the foundation film 4 and the metal coating 6 contain Ti, the formation of the foundation film 4 and the metal coating 6 can be continuously performed by using the same Ti target and by appropriately changing the composition of the gas in the apparatus.

### Second Embodiment

Regarding a second embodiment, differences from the first embodiment are mainly described, and overlapping descriptions are omitted.

FIG. 3 is a partial cross-sectional view of a watch exterior part 10A of the second embodiment.

The watch exterior part 10A illustrated in FIG. 3 includes the substrate 2 made of metal, the foundation film 4, the intermediate coating 5, and the metal coating 6 in this order. In other words, the watch exterior part 10A is the same as the watch exterior part 10 of the first embodiment except that the intermediate coating 5 is provided between the foundation film 4 and the metal coating 6.

In the second embodiment, the intermediate coating 5 is preferably provided on the surface of the foundation film 4 from the perspective of improving the adhesion to the foundation film 4. In this case, the intermediate coating 5 may be provided on at least a part of the surface of the foundation film 4.

In addition, from the perspective of improving the adhesion to the intermediate coating 5, the metal coating 6 is preferably provided on the surface of the intermediate coating 5. In this case, from the perspective of providing scratch resistance, the metal coating 6 is preferably provided at least at a location where the external impact is likely to be exerted on the surface of the intermediate coating 5.

The watch exterior part 10A of the second embodiment includes the intermediate coating 5 provided between the foundation film 4 and the metal coating 6, and thus has a structure in which the hardness of the surface side of the metal coating 6 is further enhanced. As a result, the watch exterior part 10A having more excellent scratch resistance and dent resistance is achieved.

In addition, the watch exterior part 10A of the second embodiment has the following effects as with the watch exterior part 10 of the first embodiment.

The watch exterior part 10A has a bright new silver color since the Ru film or the Ru—Ti film serving as the outermost film has less yellowness and has a brightness closer to white. In addition, since the watch exterior part 10A is bright, the fingerprint is less noticeable.

Further, since the Ru film and the Ru—Ti film serving as the outermost film have a resistance to metal allergy, a person with a metal allergy can also wear the watch exterior part 10A.

The intermediate coating 5 is described below.

Intermediate Coating

While the intermediate coating 5 is not limited, the intermediate coating 5 is preferably a film composed of TiCN. The expression “the intermediate coating 5 is composed of TiCN” means that the content of TiCN of the entire intermediate coating 5 is 90 mass % or greater. The content of TiCN is preferably 95 mass % or greater, more preferably 98 mass % or greater.

In the following description, a film composed of TiCN may be referred to as a TiCN film.

When the intermediate coating 5 is a TiCN film, the hardness in the entirety of the surface side of the metal coating 6 can be further increased, and the watch exterior part 10A that causes less depression due to scratches and dents is easily obtained. In addition, it is recognized that, when the intermediate coating 5 is a TiCN film, the influence on the aesthetic appeal of the watch exterior part 10A is small even when the thickness of the metal coating 6 is relatively thin. The reason for this is that the color tone of the Ru film or the Ru—Ti film, which are the metal coating 6, and the color tone of the TiCN film are relatively similar to each other. Therefore, in the case where the intermediate coating 5 is a TiCN film, the influence on the aesthetic appeal of the watch exterior part 10A is small even when the Ru film or the Ru—Ti film is worn or peeled, and thus the watch exterior part 10A can be used over a long period of time while maintaining the aesthetic appeal.

Note that the intermediate coating 5 may have a composition in which the TiCN film contains oxygen. In other words, the intermediate coating 5 is preferably a TiCNO film.

In the case where the intermediate coating 5 is a TiCN film, the “sum of C percentage content and N percentage content in TiCN film”, “C percentage content in TiCN film”, and “N percentage content in TiCN film” preferably fall within the following ranges.

Sum of C Percentage Content and N Percentage Content in TiCN Film

When the intermediate coating 5 is a TiCN film, the sum of the C percentage content and the N percentage content in the TiCN film is preferably from 19.5 mass % to 30 mass %. Note that the remainder in the TiCN film is preferably Ti.

When the sum of the C percentage content and the N percentage content in the TiCN film is 19.5 mass % or greater, the hardness of the entirety of the surface side of the metal coating 6 easily increases, and depressions due to scratches and dents are less caused in the metal coating 6.

When the sum of the C percentage content and the N percentage content in the TiCN film is 30.0 mass % or less, excessive increase of the internal stress of the TiCN film is suppressed. As a result, cracking is less caused in the TiCN film.

C Percentage Content in TiCN Film

The C percentage content in the TiCN film is preferably from 3.0 mass % to 12 mass %, more preferably from 5.0 mass % to 9 mass %.

When the C percentage content in the TiCN film is 3.0 mass % or greater, the hardness of the watch exterior part 10A easily increases.

When the C percentage content in the TiCN film is 12 mass % or less, excessive thickening of the color tone of the TiCN film is suppressed, and the influence on the aesthetic appeal is reduced.

N Percentage Content in TiCN Film

The N percentage content in the TiCN film is preferably from 2.0 mass % to 18 mass %, more preferably from 8.0 mass % to 16 mass %.

When the N percentage content in the TiCN film is 2.0 mass % or greater, the hardness of the watch exterior part 10A easily increases.

When the N percentage content in the TiCN film is 18 mass % or less, excessive thickening of the color tone of the TiCN film is suppressed, and the influence on the aesthetic appeal is reduced.

Note that from the perspective of reducing the impact on the aesthetic appeal, the C percentage content in the TiCN film is preferably smaller than the N percentage content in the TiCN film.

For example, in the case where the TiCN film is formed by a dry plating method, the N percentage content and the C percentage content in the TiCN film can be adjusted by changing the type and the flow rate of the gas used for the vapor film formation.

The N percentage content and the C percentage content in the TiCN film can be measured by an energy dispersive X-ray spectrometry in the following manner.

A test piece with a size of 20 mm×40 mm is cut out of the watch exterior part and the test piece is cut into two pieces. Next, the cut cross section is observed with a scanning electron microscope (SEM) (S-4800, manufactured by Hitachi High-Technologies Corporation) and the N percentage content and the C percentage content in the TiCN film are measured using an energy dispersive X-ray analyzer (EMAX, manufactured by HORIBA Ltd.) under a condition of an accelerating voltage of 15 kV.

The average thickness of the intermediate coating 5 is preferably from 0.1 μm to 2.0 μm, more preferably from 0.5 μm to 2.0 μm, still more preferably from 1.0 μm to 2.0 μm.

When the average thickness of the intermediate coating 5 is 0.1 μm or greater, the hardness of the surface side of the metal coating 6 is increased. As a result, the dent resistance is easily improved.

When the average thickness of the intermediate coating 5 is 2.0 μm or less, the adhesion to the foundation film 4 is easily ensured.

The method of measuring the average thickness of the intermediate coating 5 is described in the Examples section.

When the ratio of the average thickness of the metal coating 6 to the average thickness of the intermediate coating 5 is expressed as “the average thickness of the metal coating 6/the average thickness of the intermediate coating 5”, “the average thickness of the metal coating 6/the average thickness of the intermediate coating 5” is preferably from 0.05 to 20, more preferably from 0.08 to 4, still more preferably from 0.1 to 2.

When the “the average thickness of the metal coating 6/the average thickness of the intermediate coating 5” is from 0.05 to 20, the dent resistance is easily improved.

Characteristics of Watch Exterior Part of Second Embodiment

Nanoindenter Hardness

In the watch exterior part 10A of the second embodiment, the nanoindenter hardness measured with a load of 1.000 mN from the surface side of the metal coating 6 is preferably in the same range as the watch exterior part 10 of the above-described first embodiment.

The nanoindentation hardness can be measured in the same manner as in the first embodiment.

Vickers Hardness

In the watch exterior part 10A of the second embodiment, the Vickers hardness measured with a load of 25 gf from the surface side of the metal coating 6 is preferably 300 or greater, more preferably 800 or greater, still more preferably 1100 or greater.

Preferably, the upper limit of the Vickers hardness is, but not limited to, 2000 or less from the perspective of material selection.

When the Vickers hardness is 300 or greater, the dent resistance of the watch exterior part 10A is improved. As a result, the watch exterior part 10A can be used for a long period of time while maintaining a state where dents are less likely to be left.

The Vickers hardness can be adjusted by changing the type and the thickness of the foundation film 4, the intermediate coating 5, or the metal coating 6, for example.

The Vickers hardness can be measured in the same manner as in the first embodiment.

Method of Producing Watch Exterior Part of Second Embodiment

The method of producing the watch exterior part 10A of the second embodiment includes a foundation film forming step of forming the foundation film 4 on the substrate 2, an intermediate coating forming step of forming the intermediate coating 5 on the foundation film 4, and a metal coating step of forming the metal coating 6 on the intermediate coating 5.

In other words, the manufacturing method of the second embodiment is the same as the manufacturing method of the above-described first embodiment except that the intermediate coating film 5 is formed before the metal coating 6 is formed.

By the manufacturing method of the second embodiment, the watch exterior part 10A having excellent scratch resistance and dent resistance is obtained.

From the perspective of obtaining the watch exterior part 10A with improved durability, the manufacturing method of the second embodiment preferably includes the foundation film forming step of forming the foundation film 4 on the surface of the substrate 2, the intermediate coating forming step of forming the intermediate coating 5 on the surface of the foundation film 4, and the metal coating step of forming the metal coating 6 on the surface of the intermediate coating 5.

The intermediate coating forming step is described below.

Intermediate Coating Forming Step

The method of forming the intermediate coating 5 is not limited, and examples of the method of forming the intermediate coating 5 include the above-described methods for forming the foundation film 4.

Among them, a dry plating method is preferable as the method of forming the intermediate coating 5. The intermediate coating 5 can be formed, for example, by a dry plating method using a target made of the material of the intermediate coating 5 in a desired gas atmosphere.

By forming the intermediate coating 5 by a dry plating method, the intermediate coating 5 having uniform thickness, homogeneity, and excellent adhesion to the foundation film 4 is easily obtained. As a result, the durability of the final product of the watch exterior part 10A can be improved.

Among dry plating methods, an ion plating method is preferable from the perspective of obtaining the intermediate coating 5 with excellent adhesion to the foundation film 4.

For example, in the case where the TiCN film is formed as the intermediate coating 5 by a dry plating method, the TiCN film can be formed by performing the processing with a Ti target in a gas atmosphere containing carbon and nitrogen. A gas mixture of nitrogen gas and hydrocarbon gas such as acetylene can be used as the gas in the gas atmosphere. An inert gas such as argon gas may be contained in the gas atmosphere. In addition, a TiCNO film can be formed as the intermediate coating 5 by containing oxygen gas in the gas atmosphere.

By adjusting the combination ratio of the nitrogen gas and the hydrocarbon gas, the C percentage content and the N percentage content in the TiCN film and the C percentage content and the N percentage content in the TiCNO film can be adjusted.

Note that the average thickness of the intermediate coating 5 is adjusted by changing the film formation time.

In the case where the foundation film forming step, the intermediate coating step, and the metal coating step are performed by a dry plating method, the foundation film forming step, the intermediate coating step, and the metal coating step can be continuously performed in the same apparatus without removing the substrate 2 from the inside of the apparatus by changing the type of the target and the composition of the gas in the vapor film formation apparatus. Thus, watch exterior part 10A with improved durability and excellent adhesion between the substrate 2 and the foundation film 4, between the foundation film 4 and the intermediate coating 5 and between the intermediate coating 5 and the metal coating 6 is easily obtained. In addition, the productivity of the watch exterior part 10A can be improved.

For example, in the case where each of the foundation film 4, the intermediate coating 5, and the metal coating 6 is a film containing Ti, the formation of the films can be continuously performed with the same Ti target by appropriately changing the composition of the gas in the vapor film formation apparatus.

### OTHER EMBODIMENTS

The present disclosure is not limited to the above-described embodiments, and variations, modifications, and the like within the scope in which the object of the present disclosure can be achieved are included in the present disclosure.

For example, in the watch exterior part according to the above-described embodiment, at least one of the foundation film, the intermediate coating, and the metal coating may be composed of a plurality of films. In this case, the plurality of films may be composed of the same material or different materials.

In addition, the watch exterior part according to the above-described first embodiment may include another film at least at one of a location between the substrate and the foundation film and a location between the foundation film and the metal coating.

Further, the watch exterior part according to the above-described second embodiment may include another film at least at one of a location between the substrate and the foundation film, a location between the foundation film and the intermediate coating, and a location between the intermediate coating and the metal coating.

In addition, the method of producing the watch exterior part according to the above-described embodiments may include any desired step as necessary. For example, an intermediate process such as washing may be performed between each step. In addition, a pre-process such as cutting, grinding, polishing, and honing may be performed on the substrate.

Watch

A watch according to this embodiment includes at least one of the watch exterior parts according to the above-described embodiments. Scratches are not easily left on the surface of the watch exterior parts according to the above-described embodiments. In addition, they have a bright new silver color.

Thus, the watch of this embodiment provides excellent scratch resistance and excellent aesthetic appeal, and therefore the watch can be used for a long period of time while maintaining the aesthetic appeal.

The type of watch is not limited, and may be a quartz watch, a mechanical watch, and an electronically controlled mechanical watch, for example.

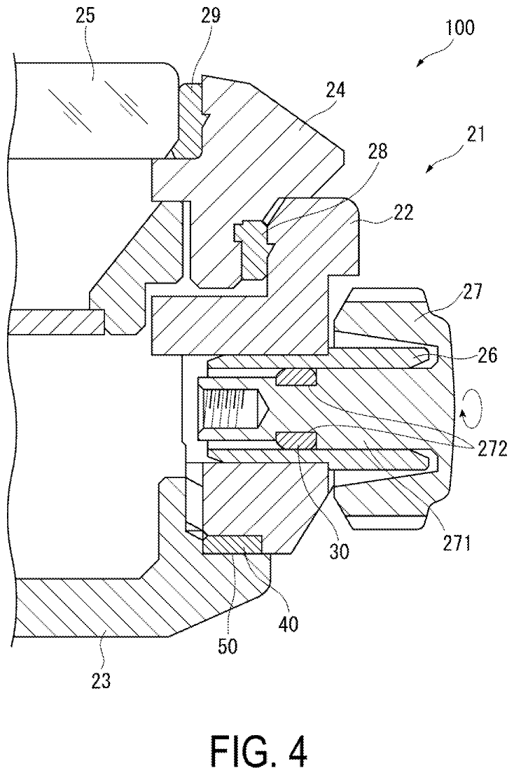

FIG. 4 is a partial cross-sectional view of the watch according to the embodiment of the present disclosure.

The watch 100 illustrated in FIG. 4 includes an exterior case 21. The exterior case 21 includes a cylindrical casing 22, a case back 23 fixed to the rear surface side of the casing 22, an annular bezel 24 fixed to surface side of the casing 22, and a glass plate 25 held by the bezel 24. In addition, a movement, which is not illustrated, is housed in the casing 22. Examples of the movement include one provided with a needle, and a dial.

A stem pipe 26 is fitted and fixed to the casing 22, and a shaft 271 of a crown 27 is rotatably inserted in the stem pipe 26.

The casing 22 and the bezel 24 are fixed by a plastic packing 28, and the bezel 24 and the glass plate 25 are fixed by a plastic packing 29.

In addition, the case back 23 is fitted or screwed to the casing 22, and a ring-shaped rubber packing or a case-back packing 40 is interposed in a compressed state in a seal portion 50. With this configuration, the seal portion 50 is liquid-tightly sealed and a waterproof function is obtained.

A groove 272 is formed on the outer face at a middle portion of the shaft 271 of the crown 27, and a ring-shaped rubber packing 30 is fitted in the groove 272. The rubber packing 30 adheres to the inner circumferential surface of the stem pipe 26 and is compressed between the inner circumferential surface and the inner surface of the groove 272. With this configuration, the portion between the crown 27 and the stem pipe 26 is liquid-tightly sealed and a waterproof function is obtained. Note that when the crown 27 is operated by rotating it, the rubber packing 30 rotates together with the shaft 271 and slides in the circumferential direction while adhering to the inner circumferential surface of the stem pipe 26.

In the watch 100 of this embodiment, at least one of the casing 22, the case back 23, the bezel 24, and the crown 27 is composed of the watch exterior part according to the first embodiment, the second embodiment, or other embodiments.

### EXAMPLES

The present disclosure is described below in more detail with Examples, but the present disclosure is not limited to the following Examples in so far as they are within the spirit and scope of the present disclosure.

### Production 1 of Watch Exterior Part

### Example 1-1

A case back of a watch case was produced as a watch exterior part.

First, a substrate having the shape of the case back of the watch case was produced by casting with stainless steel (SUS316), and thereafter the required portions were cut and polished. The thickness of the central portion of the substrate was 2 mm.

The substrate was then washed by the following method.

First, alkaline electrolytic degreasing was performed for 30 seconds, and then alkali immersion degreasing was performed for 30 seconds. Thereafter, neutralization for 10 seconds, water washing for 10 seconds and pure water washing for 10 seconds were performed.

Foundation Film Forming Step

Next, with an ion plating apparatus, a foundation film composed of Ti was formed on the surface of the washed substrate by the following method.

First, the interior of the processing chamber of the ion plating apparatus was evacuated to 2×10⁻³ Pa while preheating the interior of the processing chamber. Thereafter, with a Ti target as a target, an ionization voltage: 50V and an ionization current: 40 Å were set, and in this state, vapor film formation (ion plating) was performed for 10 minutes. As a result, a foundation film composed of Ti and having an average thickness of 0.3 μm was formed on the surface of the substrate.

Metal Coating Forming Step

Thereafter, a metal coating mainly composed of Ru was formed on the surface of the foundation film with the above-described ion plating apparatus. The metal coating was formed by the following method.

First, the interior of the processing chamber of the ion plating apparatus was evacuated to 2×10⁻³ Pa while preheating the interior of the processing chamber. Thereafter, argon gas was introduced into the processing chamber at a flow rate of 100 mL/minutes, and the atmospheric pressure in the processing chamber was set to 5.0×10⁻³ Pa. While continuously introducing the argon gas, an ionization voltage: 30V and an ionization current: 25 Å were set with a Ru target as a target, and in this state, vapor film formation (ion plating) was performed for 15 minutes. As a result, a metal coating composed of Ru and having an average thickness of 0.5 μm was formed on the surface of the foundation film.

In the above-described manner, the case back of the watch case of Example 1-1 was produced. In the following description, the case back of the watch case may be referred to as a “watch exterior part”.

### Example 1-2

A watch exterior part was produced in the same manner as in Example 1-1 except that an alloy target of Ru75 mass % and Ti25 mass % was used in the formation of the metal coating.

### Example 1-3

A watch exterior part was produced in the same manner as in Example 1-1 except that an alloy target of Ru50 mass % and Ti50 mass % was used in the formation of the metal coating.

### Example 1-4

A watch exterior part was produced in the same manner as in Example 1-1 except that an alloy target of Ru25 mass % and Ti75 mass % was used in the formation of the metal coating.

### Comparative Example 1-1

A watch exterior part was produced in the same manner as in Example 1-1 except that a Pt target was used in the formation of the metal coating.

A 20 mm×40 mm test piece was cut out of the watch exterior part produced in each Example, and the following measurements and evaluations were performed using this test piece.

Average Thickness of Foundation Film and Average Thickness of Metal Coating

The average thickness of the foundation film and the average thickness of the metal coating were measured by observing the cross-section of the test piece with a SEM (scanning electron microscope).

Specifically, in the cross-section of the test piece, the thickness of the foundation film was measured at arbitrary ten points, and the average value thereof was used as “the average thickness of the foundation film”. In addition, in the cross-section of the test piece, the thickness of the metal coating was measured at arbitrary ten points, and the average value thereof was used as “the average thickness of the metal coating”.

Also, “the average thickness of the intermediate coating” described later was measured in the same manner. Note that the average thicknesses of the foundation film, the metal coating, and the intermediate coating are adjusted by changing the vapor film formation time.

Evaluation 1 of Scratch Resistance

Nanoindenter Hardness The nanoindenter hardness was measured by the above-described method, and the scratch resistance of the watch exterior part was evaluated.

Evaluation 2 of Scratch Resistance

Falling Sand Test

A vessel with a diameter of 3 cm and a height of 8 cm was filled with sand of 51.6 g (sand diameter 0.3 mm).

The test specimen was applied onto a plate tilted at 45° relative to the ground. From a height of 90 cm from the ground, the sand in the container was dropped toward the specimen and thereafter the sand was shaken off from the specimen. This operation was performed five times, and the scratch resistance of the watch exterior part was evaluated on the basis of the following criteria.

Criteria

A: Almost no scratches were left on the surface of the metal coating

B: Scratches were left on the surface of the metal coating

C: Scratches were significantly left on the surface of the metal coating

Evaluation of Dent Resistance

The Vickers hardness was measured by the above-described method, and the dent resistance of the watch exterior part was evaluated.

Evaluation of Brightness

The L* value in the L*a*b* color space was measured and the brightness of the watch exterior part was evaluated.

The L* value was measured with a spectrophotometer (manufactured by Konica Minolta Co., Ltd.; product number: CM-5) by a method in accordance with JIS Z 8722 (2009). The larger the L* value, the higher the brightness.

Condition

Light Source: D65 defined by JIS Z 8720 (2012)

Specular Reflected Light Process: SCI (Specular Component Included)

Viewing Angle: 2°

Measurement Diameter: 8 mm

Automatic Mean Measurement: 3 times

The evaluation results of Examples 1-1 to 1-4 and Comparative Example 1-1 are shown in Table 1.

TABLE 1

| | Metal | Metal | | Dent | | Scratch Resistance | |
|---|---|---|---|---|---|---|---|
| | Type of | Coating/ | | Resistance | | | Falling |
| | Metal | Foundation | | Vickers | Brightness | Nanoindenter | Sand |
| | Coating | Film | Substrate | Hardness | L* Value | Hardness | Test |
| Example 1-1 | Ru(100) | Ru(0.5 μm)/ | SUS | 317.4 | 87.46 | 1078.25 | A |
| | | Ti(0.3 μm) | | | | | |
| Example 1-2 | Ru(75)—Ti(25) | Ru—Ti(0.5 μm)/ | SUS | 330.6 | 82.06 | 1244.57 | A |
| | | Ti(0.3 μm) | | | | | |
| Example 1-3 | Ru(50)—Ti(50) | Ru—Ti(0.5 μm)/ | SUS | 338.0 | 78.60 | 1400.00 | A |
| | | Ti(0.3 μm) | | | | | |
| Example 1-4 | Ru(25)—Ti(75) | Ru—Ti(0.5 μm)/ | SUS | 296.5 | 76.07 | 1000.00 | B |
| | | Ti(0.3 μm) | | | | | |
| Comparative | Pt(100) | Pt(0.5 μm)/ | SUS | 100.0 | 87.22 | 100.00 | C |
| Example 1-1 | | Ti(0.3 μm) | | | | | |

Table 1 and Tables 2 to 5 Described Later

The number in the parentheses of the “Metal Type of Metal Coating” indicates the content (unit: mass %) of the metal of the entire target used for the film formation.

The number in the parentheses of the “Metal Coating/Foundation Film” or “Metal Coating/Intermediate Coating/Foundation Film” indicates the average thickness (unit: nm) of each film.

From Table 1, in the case of the watch exterior part including the substrate, the foundation film, and the metal coating in this order, in Examples 1-1 to 1-4, in which the metal coating was a Ru film or a Ru—Ti film, the nanoindenter hardness was high and the result of the falling sand test was good in comparison with Comparative Example 1-1, in which the metal coating was a Pt film.

Thus, in Examples 1-1 to 1-4, watch exterior parts in which scratches are not easily left on the surface were obtained.

In addition, from the Vickers hardness value, Examples 1-1 to 1-4 were superior to Comparative Example 1-1 in dent resistance. Further, the brightness was also ensured in Examples 1-1 to 1-4.

### Production 2 of Watch Exterior Part

### Example 2-1

A watch exterior part was produced in the same manner as in Example 1-1 except that the vapor film formation time was changed in the formation of the metal coating.

### Example 2-2

A watch exterior part was produced in the same manner as in Example 2-1 except that an alloy target of Ru75 mass % and Ti25 mass % was used in the formation of the metal coating.

### Example 2-3

A watch exterior part was produced in the same manner as in Example 2-1 except that an alloy target of Ru50 mass % and Ti50 mass % was used in the formation of the metal coating.

### Example 2-4

A watch exterior part was produced in the same manner as in Example 2-1 except that an alloy target of Ru25 mass % and Ti75 mass % was used in the formation of the metal coating.

### Comparative Example 2-1

A watch exterior part was produced in the same manner as in Example 2-1 except that a Pt target was used in the formation of the metal coating.

Measurement and evaluation were performed in the same manner as in Example 1-1 for the watch exterior parts of Examples 2-1 to 2-4 and Comparative Example 2-1. The results are shown in Table 2.

TABLE 2

| | Metal | Metal | | Dent | | Scratch Resistance | |
|---|---|---|---|---|---|---|---|
| | Type of | Coating/ | | Resistance | | | Falling |
| | Metal | Foundation | | Vickers | Brightness | Nanoindenter | Sand |
| | Coating | Film | Substrate | Hardness | L* Value | Hardness | Test |
| Example 2-1 | Ru(100) | Ru(0.2 μm)/ | SUS | 250 | 87.46 | 1078.25 | A |
| | | Ti(0.3 μm) | | | | | |
| Example 2-2 | Ru(75)—Ti(25) | Ru—Ti(0.2 μm)/ | SUS | 260 | 82.06 | 1244.57 | A |
| | | Ti(0.3 μm) | | | | | |
| Example 2-3 | Ru(50)—Ti(50) | Ru—Ti(0.2 μm)/ | SUS | 270 | 78.60 | 1400.00 | A |
| | | Ti(0.3 μm) | | | | | |
| Example 2-4 | Ru(25)—Ti(75) | Ru—Ti(0.2 μm)/ | SUS | 240 | 76.07 | 1000.00 | B |
| | | Ti(0.3 μm) | | | | | |
| Comparative | Pt(100) | Pt(0.2 μm)/ | SUS | 100 | 87.22 | 100.00 | C |
| Example 2-1 | | Ti(0.3 μm) | | | | | |

For the same reasons as Examples 1-1 to 1-4, in Examples 2-1 to 2-4, watch exterior parts in which scratches are not easily left on the surface in comparison with Comparative Example 2-1 were obtained.

In addition, Examples 2-1 to 2-4 were superior to Comparative Example 2-1 in dent resistance. Further, the brightness was also ensured in Examples 2-1 to 2-4.

### Production 3 of Watch Exterior Part

### Example 3-1

A watch exterior part was produced in the same manner as in Example 1-1 except that the vapor film formation time was changed in the formation of the metal coating.

### Example 3-2

A watch exterior part was produced in the same manner as in Example 3-1 except that an alloy target of Ru75 mass % and Ti25 mass % was used in the formation of the metal coating.

### Example 3-3

A watch exterior part was produced in the same manner as in Example 3-1 except that an alloy target of Ru50 mass % and 1150 mass % was used in the formation of the metal coating.

### Example 3-4

A watch exterior part was produced in the same manner as in Example 3-1 except that an alloy target of Ru25 mass % and Ti75 mass % was used in the formation of the metal coating.

### Comparative Example 3-1

A watch exterior part was produced in the same manner as in Example 3-1 except that a Pt target was used in the formation of the metal coating.

Measurement and evaluation were performed in the same manner as in Example 1-1 for the watch exterior parts of Examples 3-1 to 3-4 and Comparative Example 3-1. The results are shown in Table 3.

TABLE 3

| | Metal | Metal | | Dent | | Scratch Resistance | |
|---|---|---|---|---|---|---|---|
| | Type of | Coating/ | | Resistance | | | Falling |
| | Metal | Foundation | | Vickers | Brightness | Nanoindenter | Sand |
| | Coating | Film | Substrate | Hardness | L* Value | Hardness | Test |
| Example 3-1 | Ru(100) | Ru(2.0 μm)/ | SUS | 900 | 87.46 | 1078.25 | A |
| | | Ti(0.3 μm) | | | | | |
| Example 3-2 | Ru(75)—Ti(25) | Ru—Ti(2.0 μm)/ | SUS | 910 | 82.06 | 1244.57 | A |
| | | Ti(0.3 μm) | | | | | |
| Example 3-3 | Ru(50)—Ti(50) | Ru—Ti(2.0 μm)/ | SUS | 920 | 78.60 | 1400.00 | A |
| | | Ti(0.3 μm) | | | | | |
| Example 3-4 | Ru(25)—Ti(75) | Ru—Ti(2.0 μm)/ | SUS | 850 | 76.07 | 1000.00 | B |
| | | Ti(0.3 μm) | | | | | |
| Comparative | Pt(100) | Pt(2.0 μm)/ | SUS | 100 | 87.22 | 100.00 | C |
| Example 3-1 | | Ti(0.3 μm) | | | | | |

For the same reasons as Examples 1-1 to 1-4, in Examples 3-1 to 3-4, watch exterior parts in which scratches are not easily left on the surface in comparison with Comparative Example 3-1 were obtained.

In addition, Examples 3-1 to 3-4 were superior to Comparative Example 3-1 in dent resistance. Further, the brightness was also ensured in Examples 3-1 to 3-4.

### Production 4 of Watch Exterior Part

### Example 4-1

A case back of a watch case was produced as a watch exterior part.

First, a substrate having the shape of the case back of the watch case was produced by casting with stainless steel (SUS316), and thereafter the required portions were cut and polished. The thickness of the central portion of the substrate was 2 mm.

The substrate was then washed by the following method.

First, alkaline electrolytic degreasing was performed for 30 seconds, and then alkali immersion degreasing was performed for 30 seconds. Thereafter, neutralization for 10 seconds, water washing for 10 seconds and pure water washing for 10 seconds were performed.

Foundation Film Forming Step

Next, with an ion plating apparatus, a foundation film composed of Ti was formed on the surface of the washed substrate by the following method.

First, the interior of the processing chamber of the ion plating apparatus was evacuated to 2×10⁻³ Pa while preheating the interior of the processing chamber. Thereafter, with a Ti target as a target, an ionization voltage: 50V and an ionization current: 40 Å were set, and in this state, vapor film formation (ion plating) was performed for 10 minutes. As a result, a foundation film composed of Ti and having an average thickness of 0.3 μm was formed on the surface of the substrate.

Intermediate Coating Forming Step

Next, an intermediate coating composed of TiCN was formed on the surface of the foundation film with the above-described ion plating apparatus. The intermediate coating was formed by the following method.

First, the interior of the processing chamber of the ion plating apparatus was evacuated to 2×10⁻³ Pa while preheating the interior of the processing chamber. Thereafter, nitrogen gas and acetylene were introduced into the processing chamber at a flow rate of 10 mL/minutes, and the atmospheric pressure (total pressure) in the processing chamber was set to 2.6×10⁻³ Pa. While continuously introducing the nitrogen gas and acetylene gas, an ionization voltage: 50V and an ionization current: 40 Å were set with a Ti target as a target, and in this state, vapor film formation (ion plating) was performed for 30 minutes. As a result, an intermediate coating composed of TiCN and having an average thickness of 1.0 μm was formed on the surface of the foundation film.

Metal Coating Forming Step

Thereafter, a metal coating composed of a Ru—Ti alloy was formed on the surface of the intermediate coating with the above-described ion plating apparatus. The metal coating was formed by the following method.

First, the interior of the processing chamber of the ion plating apparatus was evacuated to 2×10⁻³ Pa while preheating the interior of the processing chamber. Thereafter, argon gas was introduced into the processing chamber at a flow rate of 100 mL/minutes, and the atmospheric pressure in the processing chamber was set to 5.0×10⁻³ Pa. While continuously introducing the argon gas, an ionization voltage: 30V and an ionization current: 25 Å were set with an alloy target of Ru50 mass % to 1150 mass % as a target, and in this state, vapor film formation (ion plating) was performed for 10 minutes. As a result, a metal coating composed of a Ru—Ti alloy and having an average thickness of 0.3 μm was formed on the surface of the intermediate coating.

In the above-described manner, the watch exterior part of Example 4-1 was produced.

Note that the percentage content of C and the percentage content of N in the intermediate coating were measured by the above-described method. In the intermediate coating, the percentage content of C was 15 mass %, and the percentage content of N was 10 mass %.

### Comparative Example 4-1

A watch exterior part was produced in the same manner as in Example 4-1 except that the vapor film formation times in the formation of the foundation film, the metal coating, and the metal coating were changed, and that a Ti target was used in the formation of the metal coating.

### Comparative Example 4-2

A watch exterior part was produced in the same manner as in Comparative Example 4-1 except that the vapor film formation time was changed in the formation of the intermediate coating.

### Comparative Example 4-3

A watch exterior part was produced in the same manner as in Comparative Example 4-1 except that the vapor film formation time was changed in the formation of the intermediate coating, and that a Pt target was used in the formation of the metal coating.

Measurement and evaluation were performed for the watch exterior parts of Example 4-1 and Comparative Examples 4-1 to 4-3 in the same manner as in Example 1-1. The results are shown in Table 4.

TABLE 4

| | | Metal | | | | | |
|---|---|---|---|---|---|---|---|
| | | Coating/ | | | | | |
| | Metal | Intermediate | | Dent | | Scratch Resistance | |
| | Type of | Coating/ | | Resistance | | | Falling |
| | Metal | Foundation | | Vickers | Brightness | Nanoindenter | Sand |
| | Coating | Film | Substrate | Hardness | L* Value | Hardness | Test |
| Example 4-1 | Ru(50)—Ti (50) | Ru—Ti(0.3 μm)/ | SUS | 1400 | 78.60 | 1400.00 | A |
| | | TiCN(1.0 μm)/ | | | | | |
| | | Ti(0.3 μm) | | | | | |
| Comparative | Ti(100) | Ti(0.1 μm) | SUS | 295 | 76.87 | 907.55 | C |
| Example 4-1 | | TrCN(1.6 μm)/ | | | | | |
| | | Ti(0.05 μm) | | | | | |
| Comparative | Ti (100) | Ti(0.1 μm) | SUS | 247 | 76.57 | 907.55 | C |
| Example 4-2 | | TiCN(1.0 μm)/ | | | | | |
| | | Ti(0.05 μm) | | | | | |
| Comparative | Pt(100) | Pt(0.1 μm)/ | SUS | 250 | 87.22 | 907.55 | C |
| Example 4-3 | | TiCN(1.0 μm) | | | | | |
| | | Ti(0.05 μm) | | | | | |

From Table 4, in the case of the watch exterior part including the substrate, the foundation film, the intermediate coating, and the metal coating in this order, in Example 4-1, in which the metal coating is a Ru—Ti film, the nanoindenter hardness was high and the result of the falling sand test was good in comparison with Comparative Examples 4-1 and 4-2, in which the metal coating is a Ti film, and Comparative Example 4-3, in which the metal coating is Pt film.

Thus, in Example 4-1, a watch exterior part in which scratches are not easily left on the surface was obtained.

In addition, from the Vickers hardness value, Example 4-1 were superior to Comparative Examples 4-1 to 4-3 in dent resistance. Further, the brightness was also ensured in Example 4-1.

Evaluation 3 of Scratch Resistance

Arithmetic Mean Height Sa, Maximum Height Sz, and Interfacial Expansion Area Ratio Sdr

For the watch exterior parts of Example 1-1, Example 1-2, and Comparative Example 4-2, a test piece (20 mm×40 mm) was used to measure the arithmetic average height Sa, maximum height Sz, and interfacial expansion area ratio Sdr by a method in accordance with ISO 25178-2 (2012). Specifically, the surface profile of the test piece was measured using a laser shape scanning microscope (manufactured by KEYENCE; VK-X250) at a magnification of 10×.

The results are shown in Table 5.

TABLE 5

| | | Metal Coating/ | | | | |
|---|---|---|---|---|---|---|
| | | Foundation | | | | |
| | | Film or Metal | | | | |
| | Metal | Coating/ | | | | |
| | Type of | Intermediate | | Scratch Resistance | | |
| | Metal | Coating/ | | Sa | Sz | Sdr |
| | Coating | Foundation Film | Substrate | [μm] | [μm] | [—] |
| Example 1-1 | Ru(100) | Ru (0.5 μm)/ | SUS | 0.214 | 5.747 | 0.05177 |
| | | Ti(0.3 μm) | | | | |
| Example 1-2 | Ru(75)—Ti(25) | Ru—Ti(0.5 μm)/ | SUS | 0.402 | 11.385 | 0.2695 |
| | | Ti(0.3 μm) | | | | |
| Comparative | Ti(100) | Ti(0.1 μm)/ | SUS | 2.719 | 24.848 | 2.013 |
| Example 4-2 | | TiCN(1.0 μm)/ | | | | |
| | | Ti(0.05 μm) | | | | |

From Table 5, in Example 1-1 and Example 1-2, in which the metal coating was a Ru film or a Ru—Ti film, each of the arithmetic average height Sa, the maximum height Sz, and the interfacial expansion area ratio Sdr was small in comparison with Comparative Example 4-2 in which the metal coating was a Ti film.

What is claimed is:

1. A watch exterior part comprising, in order:
a substrate made of a metal;
a foundation film including any of Ti, TiCN, TiC, TiN, TiO₂, Si, and SiO₂; and
a metal coating mainly including Ru or including Ru—Ti alloy, the metal coating being configured as an outermost film.

2. The watch exterior part according to claim 1, wherein the substrate includes any of stainless steel, Ti, and Ti alloy.

3. The watch exterior part according to claim 2, wherein
a content of the Ru in an entirety of the Ru—Ti alloy is from 25 mass % to 75 mass %; and
a content of the Ti in the entirety of the Ru—Ti alloy is from 25 mass % to 75 mass %.

4. The watch exterior part according to claim 2, wherein
a content of the Ru in an entirety of the Ru—Ti alloy is from 50 mass % to 75 mass %; and
a content of the Ti in the entirety of the Ru—Ti alloy is from 25 mass % to 50 mass %.

5. The watch exterior part according to claim 2, wherein an average thickness of the metal coating is from 0.1 μm to 2.0 μm.

6. The watch exterior part according to claim 3, wherein an average thickness of the metal coating is from 0.1 μm to 2.0 μm.

7. The watch exterior part according to claim 4, wherein an average thickness of the metal coating is from 0.1 μm to 2.0 μm.

8. The watch exterior part according to claim 2, wherein an average thickness of the foundation film is from 0.01 μm to 0.50 μm.

9. The watch exterior part according to claim 3, wherein an average thickness of the foundation film is from 0.01 μm to 0.50 μm.

10. The watch exterior part according to claim 2, wherein an intermediate coating is provided between the foundation film and the metal coating.

11. The watch exterior part according to claim 3, wherein an intermediate coating is provided between the foundation film and the metal coating.

12. The watch exterior part according to claim 4, wherein an intermediate coating is provided between the foundation film and the metal coating.

13. The watch exterior part according to claim 10, wherein the intermediate coating is a film including TiCN.

14. The watch exterior part according to claim 10, wherein an average thickness of the intermediate coating is from 0.1 μm to 2.0 μm.

15. The watch exterior part according to claim 1, wherein a surface at a side provided with the metal coating has a nanoindenter hardness from 1000 to 1500, the nanoindenter hardness being measured with a load of 1.000 mN.

16. The watch exterior part according to claim 2, wherein a surface at a side provided with the metal coating has a nanoindenter hardness from 1000 to 1500, the nanoindenter hardness being measured with a load of 1.000 mN.

17. The watch exterior part according to claim 3, wherein a surface at a side provided with the metal coating has a nanoindenter hardness from 1000 to 1500, the nanoindenter hardness being measured with a load of 1.000 mN.

18. A watch comprising the watch exterior part according to claim 2.

19. A watch comprising the watch exterior part according to claim 3.

20. A watch comprising the watch exterior part according to claim 5.
